(19) United States
(12) Patent Application Publication
(10) Pub. No.: US 2024/0076485 A1
(43) Pub. Date: Mar. 7, 2024

(54) ARTIFICIAL HAIR FIBERS

(71) Applicant: DENKA COMPANY LIMITED, Tokyo (JP)

(72) Inventors: Takashi MURAOKA, Tokyo (JP); Yuki SAGARA, Tokyo (JP); Tatsuhiro MATSUBARA, Tokyo (JP); Kohei NISHINO, Tokyo (JP)

(73) Assignee: DENKA COMPANY LIMITED, Tokyo (JP)

(21) Appl. No.: 18/272,679

(22) PCT Filed: Mar. 8, 2022
(86) PCT No.: PCT/JP2022/009976

§ 371 Date: Jul. 17, 2023

(30) Foreign Application Priority Data
Mar. 15, 2021 (JP) 2021-041719

(51) Int. Cl. C08L 27/06; A41G 3/00; C08F 212/10; D01F 6/48

(52) U.S. Cl. CPC C08L 27/06; A41G 3/0083; C08F 212/10; D01F 6/48; C08L 2203/12; D10B 2401/04; D10B 2401/20; D10B 2503/08

(57) ABSTRACT

A fiber for artificial hair with low thermal shrinkage, low luster, and excellent spinnability, structured by a resin composition containing a vinyl chloride-based resin and a maleimide-based copolymer, wherein: 50 to 99 mass % of the vinyl chloride-based resin is contained in 100 mass % of the resin composition; 1 to 50 mass % of the maleimide-based copolymer is contained in 100% of the resin composition; and when a total of an aromatic vinyl-based monomer unit, a cyanide vinyl-based monomer unit, an unsaturated acid anhydride monomer unit, and a maleimide-based monomer unit in the maleimide-based copolymer is 100 mass %, the maleimide-based copolymer has 5 to 30 mass % of the maleimide-based monomer unit.

### TECHNICAL FIELD

The present invention relates to a fiber used for artificial hair, the artificial hair being such as wigs, hairpieces, and hair extensions that can be put on and off the head (hereinafter, simply referred to as “a fiber for artificial hair”).

### BACKGROUND ART

A polyvinyl chloride-based fiber has excellent strength, elongation and the like, and is widely used as a fiber for artificial hair structuring a hair decorating product. To make a synthetic resin fiber more similar to a human hair, various contrivances have been made in regards to an appearance thereof and the like.

It is disclosed in Patent Literature 1 that a polyvinyl chloride-based fiber that exhibits little thermal shrinkage even in an atmosphere at 100° C. or higher can be obtained by using a composition having a polyvinyl chloride-based resin, a chlorinated polyvinyl chloride resin, and a polymaleimide-based resin.

### CITATION LIST

### Patent Literature

[Patent Literature 1] JP-A-2004-225164

### SUMMARY OF INVENTION

### Technical Problem

The present invention addresses the problem of providing a fiber for artificial hair with low thermal shrinkage, low luster, and excellent spinnability.

### Solution to Problem

As a result of intensive study, the inventors have found that a fiber for artificial hair with low thermal shrinkage, low luster, and excellent spinnability can be obtained by using a resin composition containing a polyvinyl chloride-based resin and a maleimide-based copolymer having a specific composition.

Namely, the present invention relates to:
(1) A fiber for artificial hair structured by a resin composition containing a vinyl chloride-based resin and a maleimide-based copolymer, wherein: 50 to 99 mass % of the vinyl chloride-based resin is contained in 100 mass % of the resin composition; 1 to 50 mass % of the maleimide-based copolymer is contained in 100% of the resin composition; and when a total of an aromatic vinyl-based monomer unit, a cyanide vinyl-based monomer unit, an unsaturated acid anhydride monomer unit, and a maleimide-based monomer unit in the maleimide-based copolymer is 100 mass %, the maleimide-based copolymer has 5 to 30 mass % of the maleimide-based monomer unit.
(2) The fiber for artificial hair of (1), wherein the maleimide-based copolymer has 50 to 90 mass % of the aromatic vinyl-based monomer unit, 0.5 to 25 mass % of the cyanide vinyl-based monomer unit, and 0 to 10 mass % of the unsaturated acid anhydride monomer unit when the total of the aromatic vinyl-based monomer unit, the cyanide vinyl-based monomer unit, the unsaturated acid anhydride monomer unit, and the maleimide-based monomer unit in the maleimide-based copolymer is 100 mass %.
(3) The fiber for artificial hair of (1) or (2), wherein a ratio of a content of the vinyl chloride-based resin to a content of the maleimide-based copolymer is 80 to 99 parts by mass/i to 20 parts by mass.
(4) The fiber for artificial hair of any one of (1) to (3), wherein a weight-average molecular weight of the maleimide-based copolymer is 25000 to 120000.
(5) A hair decorating product comprising the fiber for artificial hair of any one of (1) to (4).

### Advantageous Effects of Invention

According to the present invention, a fiber for artificial hair with low thermal shrinkage, low luster, and excellent spinnability can be provided.

### DESCRIPTION OF EMBODIMENTS

### Explanation of Terms

In the present specification, for example, the description “A to B” means being equal to or greater than A and being equal to or less than B.

Hereinafter, embodiments of the present invention will be explained in detail. The present invention is not limited thereto, and various variations may be made without departing from the scope of the invention. In addition, the following embodiments can also be combined with each other.

### <Fiber for Artificial Hair>

A resin composition structuring the fiber for artificial hair of the present embodiment contains a vinyl chloride-based resin and a maleimide-based copolymer. The resin composition may also contain other synthetic resins within a range without impairing the effect of the present invention. Examples of the other synthetic resins include a vinyl-based copolymer. Specifically, an AS resin (acrylonitrile styrene resin) and a PLA resin (polylactic acid resin) are cited as examples of the other synthetic resins.

A ratio of a content of the vinyl chloride-based resin to a content of the maleimide-based copolymer in the resin composition structuring the fiber for artificial hair of the present embodiment is preferably 80 to 99 parts by mass/i to 20 parts by mass (the vinyl chloride-based resin/the maleimide-based copolymer), and more preferably 85 to 95 parts by mass/5 to 15 parts by mass. When the ratio of the content of the vinyl chloride-based resin to the content of the maleimide-based copolymer is within such a range, spinnability is excellent and a thermal shrinkage rate of the fiber for artificial hair is suppressed.

### <Vinyl Chloride-Based Resin>

The vinyl chloride-based resin is not particularly limited. A homopolymer resin which is a vinyl chloride monopolymer, and various copolymer resins are cited as examples of the vinyl chloride-based resin. One of the vinyl chloride-based resins may be used alone, or two or more of these may be used in combination. Processability and quality such as tactile sensation of the fiber for artificial hair tend to be improved by using such a resin. The fiber for artificial hair of the present embodiment may consist of one kind of fiber, or may be used as a mixture of two or more kind of fibers made of different materials. The resin composition structuring the fiber for artificial hair of the present embodiment contains 50 to 99 mass %, preferably 65 to 95 mass %, and more preferably 65 to 90 mass % of the vinyl chloride-based resin in 100 mass % of the resin composition. The content of the vinyl chloride-based resin is, specifically for example, 50, 55, 60, 65, 70, 75, 80, 85, 90, 95, or 99 mass %, and may be in the range between the two values exemplified herein.

In the present embodiment, the vinyl chloride-based resin may be a non-crosslinked vinyl chloride-based resin or a crosslinked vinyl chloride-based resin.

### <Non-Crosslinked Vinyl Chloride-Based Resin>

The non-crosslinked vinyl chloride-based resin may be a homopolymer resin or a copolymer resin. The copolymer resin in the non-crosslinked vinyl chloride-based resin is not particularly limited. Examples of the copolymer resin include copolymer resins of vinyl chloride and vinyl esters, such as a vinyl chloride-vinyl acetate copolymer resin and a vinyl chloride-vinyl propionate copolymer resin; copolymer resins of vinyl chloride and acrylic acid esters, such as a vinyl chloride-butyl acrylate copolymer resin and a vinyl chloride-acrylic acid 2-ethylhexyl copolymer resin; copolymer resins of vinyl chloride and olefins, such as a vinyl chloride-ethylene copolymer resin and vinyl chloride-propylene copolymer resin; and a vinyl chloride-acrylonitrile copolymer resin.

Among these, the vinyl chloride homopolymer is preferred. Spinnability tends to be improved by using such a resin.

A viscosity-average polymerization degree V₁ of the non-crosslinked vinyl chloride-based resin is preferably 450 to 1700, more preferably 550 to 1600, and even more preferably 650 to 1500. The viscosity-average polymerization degree V₁ of 450 or higher tends to improve strength of the fiber for artificial hair. The viscosity-average polymerization degree V₁ of 1700 or lower tends to make the fiber more resistant to breakage and improve productivity.

The viscosity-average polymerization degree can be calculated in accordance with JIS-K6721 by dissolving 200 mg of the resin in 50 mL of nitrobenzene and by measuring a specific viscosity of this polymeric solution in a thermostatic bath at 30° C. using an Ubbelohde-type viscometer.

The content of the non-crosslinked vinyl chloride-based resin is preferably 50 to 99 mass %, and more preferably 65 to 97 mass % in 100 mass % of the resin composition. The content of the non-crosslinked vinyl chloride-based resin is, specifically for example, 50, 65, 70, 75, 80, 85, 90, 95, or 99 mass %, and may be in the range between the two values exemplified herein. When the content of the non-crosslinked vinyl chloride-based resin is 50 mass % or more, spinnability of the fiber for artificial hair tends to be more improved.

### <Crosslinked Vinyl Chloride-Based Resin>

The “crosslinked” of the crosslinked vinyl chloride-based resin means that there is a branching point in a polymerized chain and there is a non-linear chain. On the other hand, “non-crosslinked” in the non-crosslinked vinyl chloride resin described above means that there is no branching point in a polymerized chain and there is a linear chain.

Such a crosslinked vinyl chloride-based resin is obtained by adding a multifunctional monomer during polymerization. The multifunctional monomer used in this process is not particularly limited. Examples of the multifunctional monomer include diacrylate compounds such as polyethylene glycol diacrylate and bisphosphoenol A modified diacrylate. The crosslinked vinyl chloride-based resin has a crosslinked structure and is a mixture of a gel component consisting mainly of vinyl chloride that is insoluble in tetrahydrofuran and a polyvinyl chloride component that is soluble in tetrahydrofuran.

A viscosity-average polymerization degree V₂ of the component soluble in tetrahydrofuran of the crosslinked vinyl chloride-based resin is preferably 700 to 2300, more preferably 700 to 1800, and even more preferably 750 to 1500. When the viscosity-average polymerization degree V₂ of the component soluble in tetrahydrofuran is within the above range, knittability and spinnability of the fiber for artificial hair tend to be more improved.

The viscosity average polymerization degree of the component of crosslinked vinyl chloride-based resin soluble in tetrahydrofuran is measured as follows. First, 1 g of the crosslinked vinyl chloride-based resin is added to 60 mL of tetrahydrofuran and left at rest for approximately 24 hours. The resin is then sufficiently dissolved using an ultrasonic cleaner. Thereafter the insoluble portion in the tetrahydrofuran solution is separated with an ultracentrifuge (30000 rpm×1 hour), and a supernatant THF solvent is collected. Subsequently, the THF solvent is volatilized, and the viscosity-average polymerization degree is measured in the same way as the non-crosslinked vinyl chloride-based resin.

The content of the crosslinked vinyl chloride-based resin is preferably 1 to 10 mass % and more preferably 3 to 7 mass % in 100 mass % of the resin composition. When the content of the crosslinked vinyl chloride-based resin is 1 mass % or more, an effect of reducing the luster of the fiber for artificial hair tends to be obtained. When the content of crosslinked vinyl chloride-based resin is 10 mass % or less, spinnability of the fiber for artificial hair tends to be more improved.

### <Chlorine Content of Vinyl Chloride-Based Resin>

The chlorine content of vinyl chloride-based resin of the present embodiment is preferably 50.0 to 60.0%, and more preferably 55.0 to 57.0%. When the chlorine content of vinyl chloride-based resin is within such a range, excellent spinnability is obtained.

<Vinyl Chloride-Based Resin with High Chlorine Content>

The vinyl chloride-based resin of the present embodiment may contain the vinyl chloride-based resin with a high chlorine content to an extent that the effect of the present invention is not hindered. For example, in 100 mass % of the resin composition, it may preferably contain less than 4%, more preferably less than 3%, and even more preferably less than 2% of a chlorinated vinyl chloride-based resin with the chlorine content exceeding 60.0%. The vinyl chloride-based resin of the present invention may contain substantially no chlorinated vinyl chloride-based resin with the chlorine content exceeding 60.0% in 100 mass % of the resin composition. By controlling the content of the chlorinated vinyl chloride-based resin with the chlorine content exceeding 60.0% to be within such a range, excellent spinnability and an effect of reducing a thermal shrinkage rate are obtained.

### <Method for Producing Vinyl Chloride-Based Resin>

The method for producing vinyl chloride-based resin is not particularly limited, and conventionally known methods such as bulk polymerization, solution polymerization, and emulsion polymerization are used.

### <Vinyl-Based Copolymer>

The resin composition structuring the fiber for artificial hair of the present embodiment preferably contains 5 to 30 mass %, and more preferably 5 to 25 mass % of the vinyl-based copolymer in 100 mass % of the resin composition. When the content of the vinyl-based copolymer is 5 mass % or more, the specific gravity of the fiber for artificial hair tends to be small. When the content of the vinyl-based copolymer is 30 mass % or less, the flame retardancy of the fiber for artificial hair tends to be improved.

### <AS Resin>

An AS resin is a copolymer having a styrene-based monomer unit and a vinyl cyanide-based monomer unit. A styrene-acrylonitrile-based copolymer is cited as an example of the AS resin.

(Meth)acrylic acid ester-based monomers such as methyl methacrylate, butyl acrylate, and ethyl acrylate; (meth)acrylic acid-based monomers such as methacrylic acid and acrylic acid; and N-substituted maleimide-based monomers such as N-phenylmaleimide can be used as other copolymerizable monomers of the AS resin.

The AS resin preferably has 60 to 90 mass % of the styrene-based monomer unit and 10 to 40 mass % of the vinyl cyanide-based monomer unit, and more preferably 65 to 80 mass % of the styrene monomer-based unit and 20 to 35 mass % of the vinyl cyanide-based monomer unit, in 100 mass % of the AS resin, as a structural unit. If the structural unit is within the above-described range, spinnability is excellent. The styrene-based monomer unit and the vinyl cyanide-based monomer unit are values measured by 13C-NMR. 100 mass % of the AS resin preferably contains 0 to 20 mass %, and more preferably 0 to 10 mass % of the other copolymerizable monomers.

### <Method for Producing AS Resin>

A known method can be adopted as a method for producing the AS resin. For example, the AS resin can be produced by bulk polymerization, solution polymerization, suspension polymerization, emulsion polymerization, and the like. As a method for operating a reactor, a continuous process, a batch process (batch), and a semi-batch process are all applicable. From a viewpoint of quality and productivity, bulk polymerization or solution polymerization is preferred, and the continuous type is preferred. Examples of solvents for bulk polymerization or solution polymerization include alkylbenzenes such as benzene, toluene, ethylbenzene and xylene; ketones such as acetone and methyl ethyl ketone; and aliphatic hydrocarbons such as hexane and cyclohexane.

In bulk polymerization or solution polymerization of the AS resin, a polymerization initiator and a chain transfer agent can be used, and a polymerization temperature is preferably within a range of 120 to 170° C. Examples of the polymerization initiator include peroxyketals such as 1,1-di(t-butylperoxy)cyclohexane, 2,2-di(t-butylperoxy)butane, 2,2-di(4,4-di-t-butylperoxycyclohexyl)propane, and 1,1-di(t-amylperoxy)cyclohexane; hydroperoxides such as cumene hydroperoxide and t-butyl hydroperoxide; alkyl peroxides such as t-butyl peroxyacetate and t-amyl peroxyisonanoate; dialkyl peroxides such as t-butylcumyl peroxide, di-t-butyl peroxide, dicumyl peroxide, and di-t-hexyl peroxide; peroxyesters such as t-butyl peroxyacetate, t-butyl peroxybenzoate, and t-butyl peroxyisopropyl monocarbonate; peroxycarbonates such as t-butylperoxyisopropyl carbonate and polyether tetrakis (t-butylperoxycarbonate); N,N′-azobis(cyclohexane-1-carbonitrile); N,N′-azobis(2-methylbutyronitrile); N,N′-azobis(2,4-dimethylvaleronitrile); and N,N′-azobis[2-(hydroxymethyl)propionitrile]. One of these may be used alone, or two or more of these may be used in combination. Examples of the chain transfer agent include n-octyl mercaptan, n-dodecylmercaptan, t-dodecyl mercaptan, α-methylstyrene dimer, ethyl thioglycolate, limonene, and terpinolene.

A known method can be adopted as a devolatilization method for removing volatile components such as an unreacted monomer and a solvent used in solution polymerization from the solution after the polymerization of the AS resin. For example, a vacuum devolatilization tank equipped with a preheater or a devolatilization extruder equipped with a vent can be used. The molten AS resin after devolatilization is transferred to a pelletizing step and extruded into strands from a porous die, which can then be processed into pellets by a cold cutting method, an air-cooled hot cutting method, or an underwater hot cutting method.

A weight-average molecular weight of the AS resin is preferably between 50000 to 200000, and more preferably 60000 to 150000, from a viewpoint of blendability with the vinyl chloride-based resin. The weight-average molecular weight of the AS resin is, specifically for example, 50000, 70000, 90000, 110000, 130000, 150000, 170000, 190000, or 200000, and may be in the range between the two values exemplified herein. The weight-average molecular weight of the AS resin is a value calculated in terms of polystyrene that is measured in the THF solvent by using gel permeation chromatography (GPC), and is a value measured in the same way as the maleimide-based copolymer (A). The weight-average molecular weight can be adjusted by the type and amount of the chain transfer agent, a solvent concentration, a polymerization temperature, and the type and amount of the polymerization initiator during polymerization.

### <Maleimide-Based Copolymer>

The maleimide-based copolymer of the present embodiment contains an aromatic vinyl-based monomer unit, a vinyl cyanide-based monomer unit, an unsaturated acid anhydride monomer unit, and a maleimide-based monomer unit.

The resin composition structuring the fiber for artificial hair of the present embodiment contains 1 to 50 mass % of the maleimide-based monomer unit in 100 mass % of the resin composition. It preferably contains 5 to 40 mass %, and more preferably 5 to 30 mass %. The content is, specifically for example, 1, 5, 8, 10, 12, 15, 20, 25, 30, 35, 40, 45, or 50 mass %, and may be in the range between the two values exemplified herein.

Hereinafter, monomer units contained in the maleimide-based copolymer will be explained.

### <Aromatic Vinyl-Based Monomer Unit>

Examples of the aromatic vinyl-based monomer unit which can be used for the maleimide-based copolymer of the present embodiment include styrene, o-methylstyrene, m-methylstyrene, p-methylstyrene, 2,4-dimethylstyrene, ethylstyrene, p-tert-butylstyrene, α-methylstyrene, and α-methyl-p-methylstyrene. Among these, styrene, which can inhibit coloration of the fiber for artificial hair, is preferred. One of the styrene-based monomers may be used alone, or two or more of these may be used in combination.

The maleimide-based copolymer of the present embodiment preferably contains 50 to 90 mass %, more preferably 60 to 85 mass %, and even more preferably 65 to 80 mass % of the aromatic vinyl-based monomer unit when the total of the aromatic vinyl-based monomer unit, the vinyl cyanide-based monomer unit, the unsaturated acid anhydride monomer unit, and the maleimide-based monomer unit in the maleimide-based copolymer is 100 mass %. The amount of the maleimide-based copolymer is, specifically for example, 45, 50, 55, 60, 65, 70, 75, 80, 85, or 90 mass %, and may be in the range between the two values exemplified herein. If the amount of the aromatic vinyl unit is less than 50 mass %, the maleimide-based copolymer may not melt with the vinyl chloride-based resin and may not be able to be blended as a result of a relative increase in other monomer components contained in the maleimide-based copolymer, or the coloring of the fiber for artificial hair may be a problem due to a higher yellow index (YI) of the maleimide-based copolymer. If the amount of the aromatic vinyl unit exceeds 90 mass %, the thermal shrinkage rate of the fiber for artificial hair may not be sufficiently suppressed.

### <Vinyl Cyanide-Based Monomer Unit>

Examples of the vinyl cyanide-based monomer unit which can be used for the maleimide-based copolymer of the present embodiment include acrylonitrile, methacrylonitrile, ethacrylonitrile, and fumaronitrile. Among these, acrylonitrile is preferred from a viewpoint of suppressing the coloration and the thermal shrinkage rate of the fiber for artificial hair. One of the vinyl cyanide-based monomer units may be used alone, or two or more of these may be used in combination.

The maleimide-based copolymer of the present embodiment preferably contains 0.5 to 25 mass %, more preferably 5 to 20 mass %, and even more preferably 5 to 15 mass % of the vinyl cyanide-based monomer unit when the total of the aromatic vinyl-based monomer unit, the vinyl cyanide-based monomer unit, the unsaturated acid anhydride monomer unit, and the maleimide-based monomer unit in the maleimide-based copolymer is 100 mass %. The amount of the vinyl cyanide-based monomer unit is, specifically for example, 0.5, 1, 5, 10, 15, 20, or 25 mass %, and may be in the range between the two values exemplified herein. If the amount of the vinyl cyanide-based monomer unit exceeds 30 mass %, the yellow index (YI) of the maleimide-based copolymer increases and the coloration of the fiber for artificial hair may be a problem.

### <Unsaturated Acid Anhydride Monomer Unit>

Examples of the unsaturated acid anhydride monomer unit which can be used for the maleimide-based copolymer of the present embodiment include maleic anhydride, itaconic anhydride, citraconic anhydride, and aconitic anhydride. Among these, maleic anhydride is preferred from a viewpoint of suppressing the thermal shrinkage rate of the fiber for artificial hair. One of the unsaturated acid anhydride monomer units may be used alone, or two or more of these may be used in combination.

The maleimide-based copolymer of the present embodiment preferably contains 0 to 10 mass %, and more preferably 0.5 to 5 mass % of the unsaturated acid anhydride monomer unit when the total of the aromatic vinyl-based monomer unit, the vinyl cyanide-based monomer unit, the unsaturated acid anhydride monomer unit, and the maleimide-based monomer unit in the maleimide-based copolymer is 100 mass %. The amount of the unsaturated acid anhydride monomer unit is, specifically for example, 0, 0.5, 0.6, 0.7, 0.8, 0.9, 1, 2, 3, 4, 5, 6, 7, 8, 9, or 10 mass %, and may be in the range between the two values exemplified herein. If the amount of the unsaturated acid anhydride monomer unit exceeds 10 mass %, flowability may decrease and blendability with the vinyl chloride-based resin may decrease.

### <Maleimide-Based Monomer Unit>

Examples of the maleimide-based monomer unit which can be used for the maleimide-based copolymer of the present embodiment include N-alkylmaleimides such as N-methylmaleimide, N-butylmaleimide, and N-cyclohexylmaleimide, and N-arylmaleimides such as N-phenylmaleimide, N-chlorphenylmaleimide, N-methylphenylmaleimide, N-methoxyphenylmaleimide, and N-tribromophenylmaleimide. Among these, N-arylmaleimide is preferred from a viewpoint of suppressing the thermal shrinkage rate of the fiber for artificial hair, and N-phenylmaleimide is more preferred. One of the maleimide-based monomers may be used alone, or two or more of these may be used in combination.

To make the maleimide-based copolymer contain the maleimide-based monomer unit, for example, a copolymer obtained by copolymerizing a raw material composed of an unsaturated dicarboxylic acid monomer unit with another monomer may be imidized with ammonia or primary amine. Alternatively, a raw material composed of a maleimide-based monomer may be copolymerized with other monomers.

The maleimide-based copolymer of the present embodiment preferably contains 5 to 30 mass %, more preferably 5 to 25 mass %, and even more preferably 10 to 20 mass % of the maleimide-based monomer unit when the total of the aromatic vinyl-based monomer unit, the vinyl cyanide-based monomer unit, the unsaturated acid anhydride monomer unit, and the maleimide-based monomer unit in the maleimide-based copolymer is 100 mass %. The amount of the maleimide-based monomer unit is, specifically for example, 5, 10, 11, 12, 13, 14, 15, 16, 17, 18, 19, 20, 21, 22, 23, 24, 25, or 30 mass %, and may be in the range between the two values exemplified herein. If the amount of the maleimide-based monomer unit is less than 5 mass %, the thermal shrinkage rate of the fiber for artificial hair may not be able to be suppressed sufficiently. If the amount of the maleimide-based monomer unit exceeds 30 mass %, the maleimide-based copolymer may not melt with the vinyl chloride-based resin and may not be able to be blended.

### <Copolymerizable Monomer>

The maleimide-based copolymer of the present embodiment may be copolymerized with copolymerizable monomers other than the aromatic vinyl-based monomer, the vinyl cyanide-based monomer, the unsaturated acid anhydride monomer unit, and the maleimide-based monomer to the extent that the effect of the present invention is not hindered. Examples of the copolymerizable monomer which can be copolymerized with the maleimide-based copolymer include acrylic ester monomers such as methyl acrylate, ethyl acrylate, and butylacrylate; methacrylic ester monomers such as methyl methacrylate and ethyl methacrylate; vinyl carboxylic acid monomers such as acrylic acid and methacrylic acid; acrylamide; and methacrylamide. One of these may be used alone, or two or more of these may be used in combination.

Such a monomer can be copolymerized to the extent that the effect of the present invention is not hindered. However, from the viewpoint of suppressing the thermal shrinkage rate of the fiber for artificial hair, the amount of such a monomer is preferably 20 mass % or less, and more preferably 10 mass % or less, when the total of the aromatic vinyl-based monomer unit, the vinyl cyanide-based monomer unit, the unsaturated acid anhydride monomer unit, and the maleimide-basedmonomer unit in the maleimide-based copolymer is 100 mass %.

### <Physical Properties of Maleimide-Based Copolymer>

### <Melt Viscosity of Maleimide-Based Copolymer>

The melt viscosity of the maleimide-based copolymer of the present embodiment is preferably 100 to 100000 Pa·s, and more preferably 200 to 70000 Pa·s. The melt viscosity is, specifically for example, 100, 200, 500, 1000, 2000, 3000, 4000, 5000, 6000, 7000, 8000, 9000, 10000, 20000, 30000, 40000, 50000, or 100000 Pa s, and may be in the range between the two values exemplified herein. If the melt viscosity is less than 100 Pa·s, the thermal shrinkage rate of the fiber for artificial hair may not be suppressed sufficiently. If the melt viscosity exceeds 100000 Pa·s, the maleimide-based copolymer of the resin composition may not melt with the vinyl chloride-based resin and blending may be impossible.

The melt viscosity was measured by a capillary die with L=40 mm and D=1 mm using a capillary rheometer 1D made by Toyo Seiki Seisaku-sho, Ltd.

The melt viscosity of the maleimide-based copolymer can be adjusted by adjusting a blending ratio of the monomer units structuring the maleimide-based copolymer. For example, the melt viscosity can be increased by increasing the content of the vinyl cyanide-based monomer unit in the maleimide-based copolymer or by increasing the content of the maleimide-based monomer unit in the maleimide-based copolymer. The melt viscosity can also be increased by increasing the weight-average molecular weight of the maleimide-based copolymer. These adjustment methods can be used in combination.

### <Weight-Average Molecular Weight of Maleimide-Based Copolymer>

The weight-average molecular weight of the maleimide-based copolymer of the present embodiment is preferably 25000 to 120000, more preferably 25000 to 100000, and even more preferably 30000 to 80000. The weight-average molecular weight is, specifically for example, 25000, 30000, 35000, 40000, 45000, 50000, 55000, 60000, 65000, 70000, 75000, 80000, 85000, 90000, 95000, 100000, 105000, 110000, 115000, or 120000, and may be in the range between the two values exemplified herein. If the weight-average molecular weight is less than 25000, the thermal shrinkage rate of the fiber for artificial hair may not be suppressed sufficiently. If weight-average molecular weight is more than 120000, a torque during blending of the resin composition containing the vinyl chloride-based resin and the maleimide-based copolymer may increase.

The weight-average molecular weight is a value calculated in terms of polystyrene that is measured by gel permeation chromatography (GPC), and can be measured under the following condition.
Name of Measuring Instrument: SYSTEM-21 Shodex (made by Showa Denko K.K.)
Column: three columns of PL gel MIXED-B (made by Polymer Laboratories Ltd.) in series
Temperature: 40° C.
Detection: differential refractive index
Solvent: tetrahydrofuran
Concentration: 2 mass %
Calibration Curve: prepared using a standard polystyrene (PS) (made by Polymer Laboratories Ltd.)

As a method for obtaining the maleimide-based copolymer with the preferred weight-average molecular weight (Mw) range of 25000 to 120000, a method for adjusting the added amounts of the solvent and the chain transfer agent can be mentioned, in addition to a method for adjusting the polymerization temperature, the polymerization time, and the added amount of the polymerization initiator. Besides, known is a method for lowering the molecular weight of the obtained copolymer by decomposition.

### <Method for Producing Maleimide-Based Copolymer>

The polymerization method of the maleimide-based copolymer includes, for example, solution polymerization and bulk polymerization. Solution polymerization is preferred from the viewpoint that the maleimide-based copolymer with a more uniform copolymerization composition can be obtained by polymerizing while adding the monomer to be copolymerized divisionally for example. The solvent for solution polymerization is preferably non-polymerizable from the viewpoint that formation of a byproduct and an adverse effect can be suppressed. Examples of the solvent include ketones such as acetone, methyl ethyl ketone, methyl isobutyl ketone, and acetophenone; ethers such as tetrahydrofuran and 1,4-dioxiane; aromatic hydrocarbons such as benzene, toluene, xylene, and chlorobenzene; N,N-dimethylformamide; dimethyl sulfoxide; and N-methyl-2-pyrrolidone. In terms of easily removing the solvent during devolatilization and recovery of the maleimide-based copolymer, methyl ethyl ketone and methyl isobutyl ketone are preferred. Polymerization processes such as a continuous polymerization process, a batch process (batch), and a semi-batch process are all applicable.

The method for producing the maleimide-based copolymer is not particularly limited. Preferably, the maleimide-based copolymer can be obtained by radical polymerization and the polymerization temperature is in the range of 80 to 150° C. The polymerization initiator is not particularly limited. For example, known azo compounds such as azobisisobutyronitrile, azobiscyclohexanecarbonitrile, azobismethylpropionitrile, and azobismethylbutyronitrile; and known organic peroxides such as benzoyl peroxide, t-butyl peroxybenzoate, 1,1-bis(t-butylperoxy)-3,3,5-trimethylcyclohexane, t-butylperoxyisopropyl monocarbonate, t-butylperoxy-2-ethylhexanoate, di-t-butylperoxide, dicumylperoxide, and ethyl-3,3-di-(t-butylperoxy)butyrate can be used. One of these may be used alone, or two or more of these may be used in combination.

In terms of polymerization reaction rate and polymerization rate control, azo compounds and organic peroxides having a 10-hour half-life of 70 to 120° C. are preferable. The amount of the polymerization initiator used is not particularly limited. Here, the amount is preferably 0.1 to 1.5 mass %, and more preferably 0.1 to 1.0 mass %, with respect to 100 mass % of the total monomer units. When the amount of the polymerization initiator used is 0.1 mass % or more, it is preferable since sufficient polymerization reaction rate can be achieved. When the amount of the polymerization initiator used is less than 1.5 mass %, the polymerization reaction rate can be suppressed, thereby allowing easy control of the reaction, resulting in easily obtaining the target molecular weight.

The chain transfer agent can be used for producing the maleimide-based copolymer. The chain transfer agent used is not particularly limited, and examples thereof include n-octylmercaptan, n-dodecylmercaptan, t-dodecylmercaptan, α-methylstyrene dimer, ethyl thioglycolate, limonene, and terpinolene. The amount of the chain transfer agent used is not particularly limited so long as it is in the range which allows to obtain the target molecular weight. Here, the amount of the chain transfer agent used is preferably 0.01 to 0.8 mass %, and more preferably 0.1 to 0.5 mass %, with respect to 100 mass % of the total monomer units. When the amount of the chain transfer agent used is 0.01 to 0.8 mass %, the target molecular weight can be obtained easily.

The method for introducing the maleimide monomer unit in the maleimide-based copolymer may be a method for copolymerizing the maleimide-based monomer, the aromatic vinyl monomer, and the vinyl cyanide monomer (direct method), or a method in which the unsaturated dicarboxylic anhydride, the aromatic vinyl monomer, and the cyanide monomer are copolymerized beforehand and the unsaturated dicarboxylic anhydride group is further converted into the maleimide monomer unit by reacting the unsaturated dicarboxylic anhydride group with ammonia or primary amine (post-imidizing method). The post-imidizing method is preferred because the amount of the remaining maleimide-based monomer in the copolymer is less.

Examples of the primary amine used in the post-imidizing method include alkyl amines such as methylamine, ethylamine, n-propylamine, iso-propylamine, n-butylamine, n-pentylamine, n-hexylamine, n-octylamine, cyclohexylamine, and decylamine; chloro- or bromo-substituted alkyl amine; and aromatic amines such as aniline, toluidine, and naphthylamine. Among these, aniline and cyclohexylamine are preferred. One of these primary amines may be used alone, or two or more of these may be used in combination. The added amount of the primary amine is not particularly limited. The added amount is preferably 0.7 to 1.1 molar equivalent, and more preferably 0.85 to 1.05 molar equivalent, with respect to the unsaturated dicarboxylic anhydride group. The molar equivalent of 0.7 or more with respect to the unsaturated dicarboxylic anhydride monomer unit in the maleimide-based is preferred since the thermal stability becomes excellent. In addition, since the molar equivalent of 1.1 or less leads to a decrease in the amount of the primary amine remaining in the maleimide-based copolymer, it is preferred.

A catalyst may be used when the maleimide monomer unit is introduced by the post-imidizing method. The catalyst can improve a cyclodehydration reaction in a reaction of ammonia or primary amine with the unsaturated dicarboxylic anhydride group, especially in a reaction to convert the unsaturated dicarboxylic anhydride group to the maleimide group. The type of the catalyst is not particularly limited. For example, tertiary amine can be used. The type of the tertiary amine is not particularly limited, and examples thereof include trimethylamine, triethylamine, tripropylamine, tributylamine, N,N-dimethylaniline, and N,N-diethylaniline. The added amount of tertiary amine is not particularly limited, and 0.01 molar equivalent or more is preferred with respect to the unsaturated dicarboxylic anhydride group. A temperature of the imidizing reaction of the present invention is preferably 100 to 250° C., and more preferably 120 to 200° C. When the temperature of the imidization reaction is 100° C. or higher, the reaction rate is sufficiently high, which is preferred in terms of productivity. When the temperature of the imidizing reaction is 250° C. or lower, it is preferable since deterioration of the physical property due to thermal degradation of the maleimide-based copolymer can be suppressed.

As the method for removing the volatile component (devolatilization method) such as the solvent used in the solution polymerization and the unreacted monomer from the solution after the solution polymerization or from the solution after the post-imidizing of the maleimide-based copolymer, a known method can be applied. For example, a vacuum devolatilization tank equipped with a heater and a devolatilization extruder equipped with a vent can be used. The molten maleimide-based copolymer after devolatilization is transferred to the pelletizing step. The molten copolymer is extruded into strands from a porous die, and processed into pellets by a cold cut method, an air-cooled hot cutting method or an underwater hot cutting method.

When the vinyl chloride-based resin is in the form of powder, it is preferable that the maleimide-based copolymer of the present embodiment is also pulverized to be in the form of powder and used. The pulverizing method is not particularly limited, and a known pulverizing technology can be used. Examples of the pulverizer which can be preferably used include a turbo mill pulverizer, a turbo disk mill pulverizer, a turbo cutter pulverizer, a jet mill pulverizer, an impact pulverizer, a hammer pulverizer, and a vibration pulverizer.

### <Other Additives>

Other additives may be used for the fiber for artificial hair of the present embodiment as necessary. Other additives may be attached to a surface of the fiber for artificial hair or mixed into the resin composition structuring the fiber.

Other additives are not particularly limited. For example, flame retardants, thermal stabilizers, and lubricants can be mentioned. When a compound equivalent to the above-described specific compounds is attached to the surface of the fiber for artificial hair as a heat stabilizer or lubricant, the amount is limited to the total content of the above-mentioned specific compounds.

### <Flame Retardant>

The flame retardant is not particularly limited if it is conventionally known. Examples of the flame retardant include bromine compounds, halogen compounds, phosphorus-containing compounds, phosphorus-halogen compounds, nitrogen compounds, and metal hydroxide-phosphorus-nitrogen compounds. Among these, preferred are bromine compounds which are bromine-based flame retardants, phosphorus-containing compounds which are phosphorus-based flame retardants, and nitrogen compounds which are nitrogen-based flame retardants.

The content of the flame retardant is preferably 3 to 30 parts by mass and more preferably 10 to 20 parts by mass with respect to 100 parts by mass of the resin composition.

The thermal stabilizer is not particularly limited if it is conventionally known. Examples of the thermal stabilizer include tin-based thermal stabilizers, Ca—Zn-based thermal stabilizers, hydrotalcite-based thermal stabilizers, epoxy-based thermal stabilizers, and β-diketone-based thermal stabilizers. Among these, Ca—Zn-based thermal stabilizers and hydrotalcite-based thermal stabilizers are preferred. Using such a thermal stabilizer can extend a product life of a product made of the fiber for artificial hair, suppress discoloration of the fiber, and suppress thermal decomposition of the composition in forming the fiber. One of these thermal stabilizers may be used alone, or two or more of these may be used in combination.

The tin-based thermal stabilizer is not particularly limited. Examples of the tin-based thermal stabilizer include mercaptotin-based thermal stabilizers such as dimethyltin mercapto, dimethyltin mercaptide, dibutyltin mercapto, dioctyltin mercapto, dioctyltin mercapto polymer, and dioctyltin mercaptoacetate; tin maleate-based thermal stabilizers such as dimethyltin maleate, dibutyltin maleate, dioctyltin maleate, and dioctyltin maleate polymers; and tin laurate-based thermal stabilizers such as dimethyltin laurate, dibutyltin laurate, and dioctyltin laurate.

The Ca—Zn-based thermal stabilizer is not particularly limited. Examples of the Ca—Zn-based thermal stabilizer include zinc stearate, calcium stearate, zinc 12-hydroxystearate, and calcium 12-hydroxystearate.

The hydrotalcite-based thermal stabilizer is not particularly limited. Examples of the hydrotalcite-based thermal stabilizer include complex salt compounds consisting of magnesium and/or alkali metals and aluminum or zinc, complex salt compounds consisting of magnesium and aluminum, and compounds in which crystal water of these complex salt compounds is dehydrated.

The epoxy-based thermal stabilizer is not particularly limited. Examples of the epoxy-based thermal stabilizer include an epoxidized soybean oil and an epoxidized linseed oil.

The β-diketone-based thermal stabilizer is not particularly limited. Examples of the β-diketone-based thermal stabilizer include stearoyl benzoylmethane and dibenzoylmethane.

The content of the thermal stabilizer is preferably 0.1 to 5.0 parts by mass, and more preferably 1.0 to 3.0 parts by mass, with respect to 100 parts by mass of the vinyl chloride-based resin. The content of the thermal stabilizer within the above-described range tends to extend the product life of the product made of the fiber for artificial hair, suppress discoloration of the fiber, and suppress thermal decomposition of the composition in forming the fiber.

### <Lubricant>

The lubricant is not particularly limited. Examples of the lubricant include metal soap-based lubricants, higher fatty acid-based lubricants, ester-based lubricants, and higher alcohol-based lubricants. Using such a lubricant is also effective for controlling a molten state of the composition and an adhesive state of the composition to metal surfaces of screws, cylinders, dies or the like in the extruder, as well as a hand touch feeling. One of these lubricants may be used alone, or two or more of these may be used in combination.

The metal soap-based lubricant is not particularly limited. Examples of the metal soap-based lubricant include metal soaps such as stearates, laurates, palmitates, and oleates of Na, Mg, Al, Ca, Ba, and the like.

Examples of the higher fatty acid lubricant include saturated fatty acids such as stearic acid, palmitic acid, myristic acid, lauric acid, and capric acid; unsaturated fatty acids such as oleic acid; and mixtures thereof.

Examples of the higher alcohol-based lubricant include stearyl alcohol, palmithyl alcohol, myristyl alcohol, lauryl alcohol, and oleyl alcohol.

Examples of the ester-based lubricant include ester-based lubricants composed of alcohol and fatty acid; pentaerythritol-based lubricants such as mono-ester, di-ester, tri-ester, tetra-ester of pentaerythritol or dipentaerythritol and higher fatty acids, and mixtures thereof; and montanic acid wax-based lubricants such as ester of montanic acid and higher alcohol such as stearyl alcohol, palmithyl alcohol, myristyl alcohol, lauryl alcohol, and oleyl alcohol.

The content of the lubricant is preferably 0.2 to 5.0 parts by mass, and more preferably 1.0 to 4.0 parts by mass, with respect to 100 parts by mass of the vinyl chloride-based resin. When the content of the lubricant is within the above-described range, an increase in die pressure, a yarn breakage, and an increase in nozzle pressure during spinning can be suppressed, and production efficiency tends to be more improved.

Furthermore, a processing aid, an anti-gloss agent, a plasticizer, a reinforcing agent, a UV absorber, an antioxidant, an antistatic agent, a filler, a pigment, a coloring enhancer, a conductivity imparting agent, a fragrance, and the like can be used as an additive other than the above-mentioned additives.

### <Method for Producing Fiber for Artificial Hair>

The method for producing the fiber for artificial hair of the present embodiment is not particularly limited. Examples of the method for producing the fiber for artificial hair include a method having a step of obtaining a synthetic resin fiber by spinning a resin composition for artificial hair, the resin composition for artificial hair containing the above-mentioned resin composition containing the vinyl chloride-based resin and the maleimide-based copolymer, and additives as necessary.

### <Preparation of Resin Composition for Fiber for Artificial Hair>

The resin composition for the fiber for artificial hair to be spun may be a pellet compound obtained by mixing a resin composition containing the vinyl chloride-based resin and the maleimide-based copolymer, and additives used as necessary, using a Henschel mixer, a super mixer, a ribbon blender, or the like, and by melting and mixing the powder compound obtained.

Kneading machines such as single-screw extruders, different direction twin-screw extruders, conical twin-screw extruders, co-rotation twin-screw extruders, co-kneaders, planetary gear extruders, and roll kneading machines can be used to produce the pellet compound.

The condition for producing the pellet compound is not particularly limited. It is preferable to set the resin temperature to be 185° C. or lower to prevent thermal degradation of the resin composition for the fiber for artificial hair. A mesh may be placed near a tip of a screw to remove metal fragments of the screw and fibers attached to a protective glove that may be mixed in small amounts in the pellet compound.

The cold cut method can be adopted for producing the pellet compound. A measure to remove machining dusts (fine powders generated when producing pellets) which may contaminate during cold cutting can be adopted. In addition, since a cutter can be nicked and machining dusts can be generated by using the cutter for a long period of time, it is preferable to replace the cutter as necessary.

### <Spinning Step>

In the spinning step, the resin composition for the fiber for artificial hair obtained as described above, for example, pellet compounds, can be extruded and melt-spun at a cylinder temperature of 150° C. to 190° C. and a nozzle temperature of 180±15° C. The cross-sectional shape of the nozzle used in this step can be set accordingly depending on the cross-sectional shape of the fiber for artificial hair to be fabricated.

The undrawn fiber melt-spun from the nozzle is introduced into a heated cylinder (a heated cylinder temperature of 250° C.) and heat-treated instantaneously, and can be taken up by a take-up machine installed at a position about 4.5 m directly below the nozzle. During take-up, a take-up speed can be adjusted such that a size of the undrawn fiber becomes as thick as desired.

A conventionally known extruder can be used in making the resin composition for the fiber for artificial hair into an undrawn yarn. For example, single-screw extruders, different direction twin-screw extruders, conical twin-screw extruders, and the like can be used.

### <Drawing and Thermal Treatment>

Undrawn fibers obtained as described above can be drawn or heat-treated. For example, it is possible that the undrawn fiber is subjected to drawing by 3 times using a drawing machine (under atmospheric air, at 105° C.), and heat treatment is performed so that the fiber length becomes 0.75 times using a heat treatment machine (under atmospheric air, at 110° C.) to make the size of the fiber 58 to 62 denier, thereby giving the fiber for artificial hair.

Furthermore, gear processing may be applied to the fiber for artificial hair obtained as described above as necessary. Gear processing is a method for applying crimping by passing a fiber bundle between two intermeshing hot gears. The gear material used, the wave shape of the gear, the number of gear ends, and the like are not particularly limited. The wave shape of the crimp can vary depending on the fiber material, the fiber size, the pressure condition between the gears, and the like. The wave shape of the crimp can be controlled by the depth of the groove in the wave shape of the gear, a surface temperature of the gear, and a processing speed.

The gear processing condition is not particularly limited. The depth of the groove in the wave shape of the gear is preferably 0.2 mm to 6 mm, and more preferably 0.5 mm to 5 mm. The gear surface temperature is 30 to 100° C., and more preferably 40 to 80° C. The processing speed is 0.5 to 10 m/min, and more preferably 1.0 to 8.0 m/min.

### <Product Using Fiber for Artificial Hair>

The fiber for artificial hair of the present embodiment can be preferably used as a hair decorating product such as hair wig, hairpiece, braid, and extension hair.

### EXAMPLES

Examples and Comparative Examples are shown below to explain the specific embodiment of the present invention in more detail. The present invention is not limited at all by the following Examples.

### <Preparation of Maleimide-Based Copolymer>

### <Production Example of Maleimide-Based Copolymer (A-1)>

73 parts by mass of styrene, 18 parts by mass of acrylonitrile, 1 parts by mass of maleic anhydride, 0.22 parts by mass of α-methylstyrene dimer, and 26 parts by mass of methylethylketone were prepared in an autoclave with a volume of approximately 120 liters equipped with a stirrer, and a gas phase part was replaced with nitrogen gas. Thereafter, the temperature was raised to 92° C. for 40 minutes with stirring. While maintaining the temperature at 92° C., a solution in which 7 parts by mass of maleic anhydride and 1.0 parts by mass of t-butylperoxy-2-ethylhexanoate were dissolved in 35 parts by mass of methylethylketone was continuously added over 4.5 hours. After the addition was completed, the temperature was raised to 120° C. and the polymerization was completed by reacting for 1 hour. Subsequently, 6 parts by mass of aniline and 0.1 parts by mass of triethylamine were added to the polymerization solution and reacted at 140° C. for 7 hours. The imidizing reaction liquid after the reaction was completed was fed into a vent-type screw extruder to remove volatile components, thereby obtaining the pellet-shaped maleimide-based copolymer A-1. The analysis result of the obtained maleimide-based copolymer is shown in Table 1.

### <Production Example of Maleimide-based Copolymer (A-2)>

64 parts by mass of styrene, 20 parts by mass of acrylonitrile, 2 parts by mass of maleic anhydride, 0.5 parts by mass of α-methylstyrene dimer, and 31 parts by mass of methylethylketone were prepared in an autoclave with a volume of approximately 120 liters equipped with a stirrer, and a gas phase part was replaced with nitrogen gas. Thereafter, the temperature was raised to 92° C. for 40 minutes with stirring. While maintaining the temperature at 92° C., a solution in which 14 parts by mass of maleic anhydride and 0.60 parts by mass of t-butylperoxy-2-ethylhexanoate were dissolved in 69 parts by mass of methylethylketone was continuously added over 5.5 hours. After the addition was completed, the temperature was raised to 120° C. and the polymerization was completed by reacting for 1 hour. Subsequently, 12 parts by mass of aniline and 0.2 parts by mass of triethylamine were added to the polymerization solution and reacted at 140° C. for 7 hours. The imidizing reaction liquid after the reaction was completed was fed into a vent-type screw extruder to remove volatile components, thereby obtaining the pellet-shaped maleimide-based copolymer A-2. The analysis result of the obtained maleimide-based copolymer is shown in Table 1.

### <Production Example of Maleimide-Based Copolymer (A-3)>

79 parts by mass of styrene, 9 parts by mass of acrylonitrile, 2 parts by mass of maleic anhydride, 0.52 parts by mass of α-methylstyrene dimer, and 33 parts by mass of methylethylketone were prepared in an autoclave with a volume of approximately 120 liters equipped with a stirrer, and a gas phase part was replaced with nitrogen gas. Thereafter, the temperature was raised to 92° C. for 40 minutes with stirring. While maintaining the temperature at 92° C., a solution in which 9 parts by mass of maleic anhydride and 0.60 parts by mass of t-butylperoxy-2-ethylhexanoate were dissolved in 47 parts by mass of methylethylketone was continuously added over 5 hours. After the addition was completed, the temperature was raised to 120° C. and the polymerization was completed by reacting for 1.5 hours. Subsequently, 9 parts by mass of aniline and 0.2 parts by mass of triethylamine were added to the polymerization solution and reacted at 140° C. for 7 hours. The imidizing reaction liquid after the reaction was completed was fed into a vent-type screw extruder to remove volatile components, thereby obtaining the pellet-shaped maleimide-based copolymer A-3. The analysis result of the obtained maleimide-based copolymer is shown in Tables 1 and 2.

### <Production Example of Maleimide-Based Copolymer (A-4)>

85 parts by mass of styrene, 7 parts by mass of acrylonitrile, 1 parts by mass of maleic anhydride, 0.72 parts by mass of α-methylstyrene dimer, and 30 parts by mass of methylethylketone were prepared in an autoclave with a volume of approximately 120 liters equipped with a stirrer, and a gas phase part was replaced with nitrogen gas. Thereafter, the temperature was raised to 92° C. for 40 minutes with stirring. While maintaining the temperature at 92° C., a solution in which 7 parts by mass of maleic anhydride and 0.80 parts by mass of t-butylperoxy-2-ethylhexanoate were dissolved in 33 parts by mass of methylethylketone was continuously added over 6 hours. After the addition was completed, the temperature was raised to 120° C. and the polymerization was completed by reacting for 1 hour. Subsequently, 5 parts by mass of aniline and 0.1 parts by mass of triethylamine were added to the polymerization solution and reacted at 140° C. for 7 hours. The imidizing reaction liquid after the reaction was completed was fed into a vent-type screw extruder to remove volatile components, thereby obtaining the pellet-shaped maleimide-based copolymer A-4. The analysis result of the obtained maleimide-based copolymer is shown in Table 1.

### <Production Example of Maleimide-Based Copolymer (A-5)>

25 parts by mass of styrene, 26 parts by mass of acrylonitrile, 2 parts by mass of maleic anhydride, 0.53 parts by mass of α-methylstyrene dimer, and 30 parts by mass of methylethylketone were prepared in an autoclave with a volume of approximately 120 liters equipped with a stirrer, and a gas phase part was replaced with nitrogen gas. Thereafter, the temperature was raised to 92° C. for 40 minutes with stirring. While maintaining the temperature at 92° C., a solution in which 34 parts by mass of styrene, 13 parts by mass of maleic anhydride, and 0.22 parts by mass of t-butylperoxy-2-ethylhexanoate were dissolved in 67 parts by mass of methylethylketone was continuously added over 3 hours. Further, after adding the maleic anhydride, a solution in which 0.18 parts by mass of t-butylperoxy-2-ethylhexanoate is dissolved in 1 parts by mass of methylethylketone was continuously added over 2.5 hours. After the addition was completed, the temperature was raised to 120° C. and the polymerization was completed by reacting for 1 hour. Subsequently, 12 parts by mass of aniline and 0.2 parts by mass of triethylamine were added to the polymerization solution and reacted at 140° C. for 7 hours. The imidizing reaction liquid after the reaction was completed was fed into a vent-type screw extruder to remove volatile components, thereby obtaining the pellet-shaped maleimide-based copolymer A-5. The analysis result of the obtained maleimide-based copolymer is shown in Table 1.

### <Production Example of Maleimide-Based Copolymer (A-6)>

23 parts by mass of styrene, 26 parts by mass of acrylonitrile, 2 parts by mass of maleic anhydride, 0.32 parts by mass of α-methylstyrene dimer, and 32 parts by mass of methylethylketone were prepared in an autoclave with a volume of approximately 120 liters equipped with a stirrer, and a gas phase part was replaced with nitrogen gas. Thereafter, the temperature was raised to 92° C. for 40 minutes with stirring. While maintaining the temperature at 92° C., a solution in which 33 parts by mass of styrene, 16 parts by mass of maleic anhydride, and 0.22 parts by mass of t-butylperoxy-2-ethylhexanoate were dissolved in 81 parts by mass of methylethylketone was continuously added over 3 hours. Further, after adding the maleic anhydride, a solution in which 0.18 parts by mass of t-butylperoxy-2-ethylhexanoate is dissolved in 1 parts by mass of methylethylketone was continuously added over 2.5 hours. After the addition was completed, the temperature was raised to 120° C. and the polymerization was completed by reacting for 1 hour. Subsequently, 14 parts by mass of aniline and 0.3 parts by mass of triethylamine were added to the polymerization solution and reacted at 140° C. for 7 hours. The imidizing reaction liquid after the reaction was completed was fed into a vent-type screw extruder to remove volatile components, thereby obtaining the pellet-shaped maleimide-based copolymer A-6. The analysis result of the obtained maleimide-based copolymer is shown in Table 1.

### <Production Example of Maleimide-Based Copolymer (A-7)>

94 parts by mass of styrene, 2 parts by mass of acrylonitrile, 0.4 parts by mass of maleic anhydride, 0.58 parts by mass of α-methylstyrene dimer, and 28 parts by mass of methylethylketone were prepared in an autoclave with a volume of approximately 120 liters equipped with a stirrer, and a gas phase part was replaced with nitrogen gas. Thereafter, the temperature was raised to 92° C. for 40 minutes with stirring. While maintaining the temperature at 92° C., a solution in which 4 parts by mass of maleic anhydride and 1.0 parts by mass of t-butylperoxy-2-ethylhexanoate were dissolved in 18 parts by mass of methylethylketone was continuously added over 7.5 hours. After the addition was completed, the temperature was raised to 120° C. and the polymerization was completed by reacting for 1 hour. Subsequently, 3 parts by mass of aniline and 0.1 parts by mass of triethylamine were added to the polymerization solution and reacted at 140° C. for 7 hours. The imidizing reaction liquid after the reaction was completed was fed into a vent-type screw extruder to remove volatile components, thereby obtaining the pellet-shaped maleimide-based copolymer A-7. The analysis result of the obtained maleimide-based copolymer is shown in Table 1.

### <Production Example of Maleimide-Based Copolymer (A-8)>

88 parts by mass of styrene, 1 parts by mass of maleic anhydride, 0.48 parts by mass of α-methylstyrene dimer, and 29 parts by mass of methylethylketone were prepared in an autoclave with a volume of approximately 120 liters equipped with a stirrer, and a gas phase part was replaced with nitrogen gas. Thereafter, the temperature was raised to 92° C. for 40 minutes with stirring. While maintaining the temperature at 92° C., a solution in which 11 parts by mass of maleic anhydride and 1.20 parts by mass of t-butylperoxy-2-ethylhexanoate were dissolved in 56 parts by mass of methylethylketone was continuously added over 8.5 hours. After the addition was completed, the temperature was raised to 120° C. and the polymerization was completed by reacting for 1 hour. Subsequently, 9 parts by mass of aniline and 0.2 parts by mass of triethylamine were added to the polymerization solution and reacted at 140° C. for 7 hours. The imidizing reaction liquid after the reaction was completed was fed into a vent-type screw extruder to remove volatile components, thereby obtaining the pellet-shaped maleimide-based copolymer A-8. The analysis result of the obtained maleimide-based copolymer is shown in Table 1.

### <Production Example of Maleimide-Based Copolymer (A-9)>

27 parts by mass of styrene, 33 parts by mass of acrylonitrile, 2 parts by mass of maleic anhydride, 0.11 parts by mass of α-methylstyrene dimer, and 24 parts by mass of methylethylketone were prepared in an autoclave with a volume of approximately 120 liters equipped with a stirrer, and a gas phase part was replaced with nitrogen gas. Thereafter, the temperature was raised to 92° C. for 40 minutes with stirring. While maintaining the temperature at 92° C., a solution in which 31 parts by mass of styrene, 7 parts by mass of maleic anhydride, and 0.38 parts by mass of t-butylperoxy-2-ethylhexanoate were dissolved in 37 parts by mass of methylethylketone was continuously added over 3.5 hours. Further, after adding the maleic anhydride, a solution in which 0.22 parts by mass of t-butylperoxy-2-ethylhexanoate is dissolved in 2 parts by mass of methylethylketone was continuously added over 2 hours. After the addition was completed, the temperature was raised to 120° C. and the polymerization was completed by reacting for 1 hour. Subsequently, 6 parts by mass of aniline and 0.1 parts by mass of triethylamine were added to the polymerization solution and reacted at 140° C. for 7 hours. The imidizing reaction liquid after the reaction was completed was fed into a vent-type screw extruder to remove volatile components, thereby obtaining the pellet-shaped maleimide-based copolymer A-9. The analysis result of the obtained maleimide-based copolymer is shown in Table 1.

### <Production Example of Maleimide-Based Copolymer (A-10)>

63 parts by mass of styrene, 22 parts by mass of acrylonitrile, 2 parts by mass of maleic anhydride, 0.59 parts by mass of α-methylstyrene dimer, and 30 parts by mass of methylethylketone were prepared in an autoclave with a volume of approximately 120 liters equipped with a stirrer, and a gas phase part was replaced with nitrogen gas. Thereafter, the temperature was raised to 92° C. for 40 minutes with stirring. While maintaining the temperature at 92° C., a solution in which 13 parts by mass of maleic anhydride and 0.44 parts by mass of t-butylperoxy-2-ethylhexanoate are dissolved in 69 parts by mass of methylethylketone was continuously added over 4 hours. Further, after adding the maleic anhydride, a solution in which 0.16 parts by mass of t-butylperoxy-2-ethylhexanoate was dissolved in 1 parts by mass of methylethylketone was continuously added over 1.5 hours. After the addition was completed, the temperature was raised to 120° C. and the polymerization was completed by reacting for 1 hour. Subsequently, 3 parts by mass of aniline and 0.2 parts by mass of triethylamine were added to the polymerization solution and reacted at 140° C. for 7 hours. The imidizing reaction liquid after the reaction was completed was fed into a vent-type screw extruder to remove volatile components, thereby obtaining the pellet-shaped maleimide-based copolymer A-10. The analysis result of the obtained maleimide-based copolymer is shown in Table 1.

### <Production Example of Maleimide-Based Copolymer (A-11)>

79 parts by mass of styrene, 9 parts by mass of acrylonitrile, 2 parts by mass of maleic anhydride, 1.00 parts by mass of α-methylstyrene dimer, and 33 parts by mass of methylethylketone were prepared in an autoclave with a volume of approximately 120 liters equipped with a stirrer, and a gas phase part was replaced with nitrogen gas. Thereafter, the temperature was raised to 92° C. for 40 minutes with stirring. While maintaining the temperature at 92° C., a solution in which 9 parts by mass of maleic anhydride and 0.60 parts by mass of t-butylperoxy-2-ethylhexanoate were dissolved in 47 parts by mass of methylethylketone was continuously added over 5 hours.

After the addition was completed, the temperature was raised to 120° C. and the polymerization was completed by reacting for 1.5 hours. Subsequently, 9 parts by mass of aniline and 0.2 parts by mass of triethylamine were added to the polymerization solution and reacted at 140° C. for 7 hours. The imidizing reaction liquid after the reaction was completed was fed into a vent-type screw extruder to remove volatile components, thereby obtaining the pellet-shaped maleimide-based copolymer A-11. The analysis result of the obtained maleimide-based copolymer is shown in Table 2.

### <Production Example of Maleimide-Based Copolymer (A-12)>

79 parts by mass of styrene, 9 parts by mass of acrylonitrile, 2 parts by mass of maleic anhydride, and 33 parts by mass of methylethylketone were prepared in an autoclave with a volume of approximately 120 liters equipped with a stirrer, and a gas phase part was replaced with nitrogen gas. Thereafter, the temperature was raised to 92° C. for 40 minutes with stirring. While maintaining the temperature at 92° C., a solution in which 9 parts by mass of maleic anhydride and 0.60 parts by mass of t-butylperoxy-2-ethylhexanoate were dissolved in 47 parts by mass of methylethylketone was continuously added over 5 hours.

After the addition was completed, the temperature was raised to 120° C. and the polymerization was completed by reacting for 1.5 hours. Subsequently, 9 parts by mass of aniline and 0.2 parts by mass of triethylamine were added to the polymerization solution and reacted at 140° C. for 7 hours. The imidizing reaction liquid after the reaction was completed was fed into a vent-type screw extruder to remove volatile components, thereby obtaining the pellet-shaped maleimide-based copolymer A-12. The analysis result of the obtained maleimide-based copolymer is shown in Table 2.

### <Production Example of Maleimide-Based Copolymer (B-1)>

77 parts by mass of styrene, 19 parts by mass of acrylonitrile, 1 parts by mass of maleic anhydride, and 25 parts by mass of methylethylketone were prepared in an autoclave with a volume of approximately 120 liters equipped with a stirrer, and a gas phase part was replaced with nitrogen gas. Thereafter, the temperature was raised to 92° C. for 40 minutes with stirring. While maintaining the temperature at 92° C., a solution in which 3 parts by mass of maleic anhydride and 0.82 parts by mass of t-butylperoxy-2-ethylhexanoate were dissolved in 23 parts by mass of methylethylketone was continuously added over 4.5 hours. Further, after adding the maleic anhydride, a solution in which 0.18 parts by mass of t-butylperoxy-2-ethylhexanoate is dissolved in 1 parts by mass of methylethylketone was continuously added over 1 hour. After the addition was completed, the temperature was raised to 120° C. and the polymerization was completed by reacting for 1 hour. Subsequently, 2 parts by mass of aniline and 0.1 parts by mass of triethylamine were added to the polymerization solution and reacted at 140° C. for 7 hours. The imidizing reaction liquid after the reaction was completed was fed into a vent-type screw extruder to remove volatile components, thereby obtaining the pellet-shaped maleimide-based copolymer B-1. The analysis result of the obtained maleimide-based copolymer is shown in Table 2.

### <Production Example of Maleimide-Based Copolymer (B-2)>

22 parts by mass of styrene, 10 parts by mass of acrylonitrile, 3 parts by mass of maleic anhydride, 0.45 parts by mass of α-methylstyrene dimer, and 39 parts by mass of methylethylketone were prepared in an autoclave with a volume of approximately 120 liters equipped with a stirrer, and a gas phase part was replaced with nitrogen gas. Thereafter, the temperature was raised to 92° C. for 40 minutes with stirring. While maintaining the temperature at 92° C., a solution in which 41 parts by mass of styrene, 23 parts by mass of maleic anhydride, and 0.42 parts by mass of t-butylperoxy-2-ethylhexanoate were dissolved in 116 parts by mass of methylethylketone was continuously added over 5 hours. After the addition was completed, the temperature was raised to 120° C. and the polymerization was completed by reacting for 1 hour. Subsequently, 23 parts by mass of aniline and 0.4 parts by mass of triethylamine were added to the polymerization solution and reacted at 140° C. for 7 hours. The imidizing reaction liquid after the reaction was completed was fed into a vent-type screw extruder to remove volatile components, thereby obtaining the pellet-shaped maleimide-based copolymer B-2. The analysis result of the obtained maleimide-based copolymer is shown in Table 2.

### <Weight-Average Molecular Weight of Maleimide-Based Copolymer>

The weight-average molecular weight of the maleimide-based copolymer is a value calculated in terms of polystyrene that is measured by gel permeation chromatography (GPC) and was measured under the following condition.
Name of Measuring Instrument: SYSTEM-21 Shodex (made by Showa Denko K.K.)
Column: three columns of PL gel MIXED-B (made by Polymer Laboratories Ltd.) in series
Temperature: 40° C.
Detection: differential refractive index
Solvent: tetrahydrofuran
Concentration: 2 mass %
Calibration Curve: prepared using a standard polystyrene (PS) (made by Polymer Laboratories Ltd.)

### <Melt Viscosity of Maleimide-Based Copolymer>

The melt viscosity of the maleimide-based copolymer was measured using a capillary die with L=40 mm and D=1 mm under a condition with a temperature of 190° C. and a shear rate of 100/sec. The measuring machine used was a capillary rheometer 1D made by Toyo Seiki Seisaku-sho, Ltd.

### <Preparation of Fiber>

The non-crosslinked vinyl chloride-based resin, the cross-linked vinyl chloride-based resin, the AS resin, and the maleimide-based copolymer were mixed in a blender in a ratio shown in Tables 1 and 2 below, and compounded using an extruder with a diameter of 40 mm at a cylinder temperature of 130 to 170° C. to fabricate pellets. The pellets obtained were melt-spun by the extruder.

### (Raw Material Used) Listed Below are the Raw Materials Used in Each Example and Each Comparative Example.

### (1) Vinyl Chloride-Based Resin

Non-crosslinked vinyl chloride-based resin (made by Taiyo Vinyl Corporation, product name: TH1000, viscosity-average polymerization degree 1000)
Cross-linked vinyl chloride-based resin (made by Shin-Etsu Chemical, product name GR800T, viscosity-average polymerization degree 800 for the component dissolved in tetrahydrofuran)

### (2) Vinyl-Based Copolymer Resin

AS resin (GR-AT-6S made by Denka Company Limited, 68 mass % of the styrene monomer unit, 32 mass % of the vinyl cyanide-based monomer unit, the weight-average molecular weight 90000)

### (3) Maleimide-Based Copolymer

Used were (A-1) to (A-12) and (B-1) to (B-2) that were obtained according to the above-mentioned Production Examples.

The fiber was then heat-treated for approximately 0.5 to 1.5 seconds in a heated cylinder located directly under the nozzle to make a 150-dtex-fiber. Next, the melt-spun fiber was drawn to 300% in an air atmosphere at 100° C. The drawn fiber was heat-shrunk in an air atmosphere at 120° C. until the total length of the fiber shrank to 75% of the length before treatment, resulting in obtaining a 670-dtex-fiber for artificial hair. The results of each evaluation using the obtained fiber for artificial hair are shown in Tables 1 and 2.

### <Various Measurements and Evaluations>

Various characteristics and physical properties were measured and evaluated by the following method.

### <Thermal Shrinkage Rate>

Samples adjusted to 100 mm in length were prepared from the fibers for artificial hair in Examples and Comparative Examples, immersed in hot water at 95° C. for 30 seconds, and the lengths of the samples before and after immersion were measured. Thermal shrinkage rate was determined according to the following formula (1).

Thermal shrinkage rate (%)={(length before immersion)−(length after immersion at 95° C. for 30 seconds)}/(length before immersion)×100 (1)

### <Luster>

In each of Examples and Comparative Examples, a fiber bundle for artificial hair having a length of 200 mm and a weight of 20 g was prepared. The luster was visually observed under sunlight by 10 technicians in the field of processing a fiber for artificial hair (work experience of 5 years or more), compared with the luster of human hair, and evaluated according to the following evaluation criteria.

### (Evaluation Criteria)

A: 9 or more out of 10 technicians judged that no difference from human hair could be recognized.
B: 6 to 8 out of 10 technicians judged that no difference from human hair could be recognized.
C: 3 to 5 out of 10 technicians judged that no difference from human hair could be recognized.
D: 2 or less out of 10 technicians judged that no difference from human hair could be recognized.

### <Spinnability>

While melt-spinning to produce an undrawn yarn, an occurrence of yarn breakage was visually observed, and the spinnability was evaluated according to the following criteria.

### (Evaluation Criteria)

A: Yarn breakage occurs 1 time at maximum/i hour
B: Yarn breakage occurs 2 to 3 times/i hour
C: Yarn breakage occurs 4 or more times/i hour

TABLE 1

| | | | Examples | | | | | |
|---|---|---|---|---|---|---|---|---|
| | | | 1 | 2 | 3 | 4 | 5 | 6 |
| Vinyl Chloride-based Resin | Parts by Mass of Polyvinyl | TH1000 | 90 | 90 | 90 | 90 | 90 | 90 |
| | Chloride-based Resin | | | | | | | |
| | Parts by Mass of Crosslinked | GR800T | | | | | | |
| | Vinyl Chloride-based Resin | | | | | | | |
| Vinyl-based Copolymer Resin | Parts by Mass of AS Resin | GR-AT-6S | | | | | | |
| Maleimide-based | Parts by Mass of Maleimide- | | 10 | 10 | 10 | 10 | 10 | 10 |
| Copolymer | based Copolymer | | | | | | | |
| Ratio of Content of Vinyl Chloride-based Resin | | | 90/10 | 90/10 | 90/10 | 90/10 | 90/10 | 90/10 |
| to Content of Maleimide-based Copolymer | | | | | | | | |
| Vinyl Chloride-based Resin (parts by mass)/ | | | | | | | | |
| Maleimide-based Copolymer (parts by mass) | | | | | | | | |
| Maleimide-based Copolymer | Copolymer | | A-1 | A-2 | A-3 | A-4 | A-5 | A-6 |
| | Parts by Mass of Aromatic | Styrene | 70 | 61 | 71 | 79 | 54 | 51 |
| | Vinyl-based Monomer | | | | | | | |
| | Parts by Mass of Vinyl | Acrylonitrile | 17 | 17 | 9 | 7 | 23 | 22 |
| | Cyanide-based Monomer | | | | | | | |
| | Parts by Mass of Unsaturated | Maleic Anhydride | 2 | 3 | 2 | 3 | 2 | 3 |
| | Acid Anhydride Monomer | | | | | | | |
| | Parts by Mass of Maleimide- | Maleimide | 11 | 19 | 18 | 11 | 21 | 24 |
| | based Monomer | | | | | | | |
| | Mw | ×10⁴ | 8.7 | 8.0 | 7.8 | 4.7 | 6.7 | 8.6 |
| | Melt Viscosity(190° C., 100/sec) | Pa · s | 2920 | 8130 | 3070 | 230 | 7100 | 35700 |
| Thermal Shrinkage Rate | | % | 4 | 3 | 4 | 4 | 4 | 4 |
| Luster | | | B | B | A | A | B | B |
| Spinnability | | | A | A | A | A | A | B |

| | | | Examples | | | |
|---|---|---|---|---|---|---|
| | | | 7 | 8 | 9 | 10 |
| Vinyl Chloride-based Resin | Parts by Mass of Polyvinyl | TH1000 | 90 | 90 | 90 | 90 |
| | Chloride-based Resin | | | | | |
| | Parts by Mass of Crosslinked | GR800T | | | | |
| | Vinyl Chloride-based Resin | | | | | |
| Vinyl-based Copolymer Resin | Parts by Mass of AS Resin | GR-AT-6S | | | | |
| Maleimide-based | Parts by Mass of Maleimide- | | 10 | 10 | 10 | 10 |
| Copolymer | based Copolymer | | | | | |
| Ratio of Content of Vinyl Chloride-based Resin | | | 90/10 | 90/10 | 90/10 | 90/10 |
| to Content of Maleimide-based Copolymer | | | | | | |
| Vinyl Chloride-based Resin (parts by mass)/ | | | | | | |
| Maleimide-based Copolymer (parts by mass) | | | | | | |
| Maleimide-based Copolymer | Copolymer | | A-7 | A-8 | A-9 | A-10 |
| | Parts by Mass of Aromatic | Styrene | 91 | 81 | 59 | 63 |
| | Vinyl-based Monomer | | | | | |
| | Parts by Mass of Vinyl | Acrylonitrile | 2 | 0 | 27 | 20 |
| | Cyanide-based Monomer | | | | | |
| | Parts by Mass of Unsaturated | Maleic Anhydride | 1 | 3 | 2 | 11 |
| | Acid Anhydride Monomer | | | | | |
| | Parts by Mass of Maleimide- | Maleimide | 6 | 16 | 12 | 6 |
| | based Monomer | | | | | |
| | Mw | ×10⁴ | 6.8 | 5.1 | 11.8 | 7.1 |
| | Melt Viscosity(190° C., 100/sec) | Pa · s | 140 | 340 | 37200 | 2790 |
| Thermal Shrinkage Rate | | % | 8 | 8 | 4 | 7 |
| Luster | | | A | A | C | B |
| Spinnability | | | A | A | A | A |

TABLE 2

| | | | Examples | | | | | |
|---|---|---|---|---|---|---|---|---|
| | | | 11 | 12 | 13 | 14 | 15 | 16 |
| Vinyl Chloride- | Parts by Mass of Polyvinyl | TH1000 | 90 | 90 | 99 | 50 | 85 | 65 |
| | Chloride-based Resin | | | | | | | |
| based Resin | Parts by Mass of Crosslinked | GR800T | | | | | 5 | 5 |
| | Vinyl Chloride-based Resin | | | | | | | |
| Vinyl-based | Parts by Mass of AS Resin | GR-AT-6S | | | | | | 20 |
| Copolymer Resin | | | | | | | | |
| Maleimide-based | Parts by Mass of | | 10 | 10 | 1 | 50 | 10 | 10 |
| Copolymer | Maleimide-based Copolymer | | | | | | | |
| Ratio of Content of Vinyl Chloride-based Resin | | | 90/10 | 90/10 | 99/1 | 50/50 | 90/10 | 87.5/12.5 |
| to Content of Maleimide-based Copolymer | | | | | | | | |
| Vinyl Chloride-based Resin (parts by mass)/ | | | | | | | | |
| Maleimide-based Copolymer (parts by mass) | | | | | | | | |
| Maleimide-based | Copolymer | | A-11 | A-12 | A-3 | A-3 | A-3 | A-3 |
| Copolymer | Parts by Mass of Aromatic | Styrene | 71 | 71 | 71 | 71 | 71 | 71 |
| | Vinyl-based Monomer | | | | | | | |
| | Parts by Mass of Vinyl | Acrylonitrile | 9 | 9 | 9 | 9 | 9 | 9 |
| | Cyanide-based Monomer | | | | | | | |
| | Parts by Mass of Unsaturated | Maleic Anhydride | 2 | 2 | 2 | 2 | 2 | 2 |
| | Acid Anhydride Monomer | | | | | | | |
| | Parts by Mass of | Maleimide | 18 | 18 | 18 | 18 | 18 | 18 |
| | Maleimide-based Monomer | | | | | | | |
| | Mw | ×10⁴ | 2.3 | 13.9 | 7.8 | 7.8 | 7.8 | 7.8 |
| | Melt Viscosity(190° C., 100/sec) | Pa · s | 150 | 86700 | 3070 | 3070 | 3070 | 3070 |
| Thermal | | % | 7 | 4 | 7 | 2 | 4 | 4 |
| Shrinkage Rate | | | | | | | | |
| Luster | | | A | A | C | A | A | A |
| Spinnability | | | A | B | A | B | A | A |

| | | | | | Comparative | |
|---|---|---|---|---|---|---|
| | | | Examples | Reference | Examples | |
| | | | 17 | Example | 1 | 2 |
| Vinyl Chloride- | Parts by Mass of Polyvinyl | TH1000 | 80 | 100 | 90 | 90 |
| | Chloride-based Resin | | | | | |
| based Resin | Parts by Mass of Crosslinked | GR800T | 0 | | | |
| | Vinyl Chloride-based Resin | | | | | |
| Vinyl-based | Parts by Mass of AS Resin | GR-AT-6S | 20 | | | |
| Copolymer Resin | | | | | | |
| Maleimide-based | Parts by Mass of | | 10 | | 10 | 10 |
| Copolymer | Maleimide-based Copolymer | | | | | |
| Ratio of Content of Vinyl Chloride-based Resin | | | 89/11 | 100/0 | 90/10 | 90/10 |
| to Content of Maleimide-based Copolymer | | | | | | |
| Vinyl Chloride-based Resin (parts by mass)/ | | | | | | |
| Maleimide-based Copolymer (parts by mass) | | | | | | |
| Maleimide-based | Copolymer | | A-3 | | B-1 | B-2 |
| Copolymer | Parts by Mass of Aromatic | Styrene | 71 | | 75 | 52 |
| | Vinyl-based Monomer | | | | | |
| | Parts by Mass of Vinyl | Acrylonitrile | 9 | | 19 | 8 |
| | Cyanide-based Monomer | | | | | |
| | Parts by Mass of Unsaturated | Maleic Anhydride | 2 | | 2 | 2 |
| | Acid Anhydride Monomer | | | | | |
| | Parts by Mass of | Maleimide | 18 | | 4 | 38 |
| | Maleimide-based Monomer | | | | | |
| | Mw | ×10⁴ | 7.8 | | 11 | 9.3 |
| | Melt Viscosity(190° C., 100/sec) | Pa · s | 3070 | | 3950 | 149000 |
| Thermal | | % | 4 | 10 | 9 | Not melt- |
| Shrinkage Rate | | | | | | kneadable |
| Luster | | | A | D | B | |
| Spinnability | | | A | A | A | A |

From the results in Tables 1 and 2, it can be seen that the fiber for artificial hair in Examples has low thermal shrinkage rate, low luster, and excellent spinnability. On the other hand, the fiber for artificial hair in Comparative Examples is inferior to Example in one or more aspects of thermal shrinkage, luster, and spinnability. In addition, melt-kneading was impossible in Comparative Example 2, and the fiber for artificial hair could not be obtained.

### INDUSTRIAL APPLICABILITY

The present invention has an industrial potential as a fiber for artificial hair, the artificial hair being such as wigs, hairpieces, and hair extensions that can be put on and off the head.

1. A fiber for artificial hair structured by a resin composition containing a vinyl chloride-based resin and a maleimide-based copolymer, wherein:
50 to 99 mass % of the vinyl chloride-based resin is contained in 100 mass % of the resin composition;
1 to 50 mass % of the maleimide-based copolymer is contained in 100% of the resin composition; and
when a total of an aromatic vinyl-based monomer unit, a cyanide vinyl-based monomer unit, an unsaturated acid anhydride monomer unit, and a maleimide-based monomer unit in the maleimide-based copolymer is 100 mass %, the maleimide-based copolymer has 5 to 30 mass % of the maleimide-based monomer unit.

2. The fiber for artificial hair of claim 1, wherein the maleimide-based copolymer has 50 to 90 mass % of the aromatic vinyl-based monomer unit, 0.5 to 25 mass % of the cyanide vinyl-based monomer unit, and 0 to 10 mass % of the unsaturated acid anhydride monomer unit when the total of the aromatic vinyl-based monomer unit, the cyanide vinyl-based monomer unit, the unsaturated acid anhydride monomer unit, and the maleimide-based monomer unit in the maleimide-based copolymer is 100 mass %.

3. The fiber for artificial hair of claim 1, wherein a ratio of a content of the vinyl chloride-based resin to a content of the maleimide-based copolymer is 80 to 99 parts by mass/1 to 20 parts by mass.

4. The fiber for artificial hair of claim 1, wherein a weight-average molecular weight of the maleimide-based copolymer is 25000 to 120000.

5. A hair decorating product comprising the fiber for artificial hair of claim 1.

6. The fiber for artificial hair of claim 2, wherein a ratio of a content of the vinyl chloride-based resin to a content of the maleimide-based copolymer is 80 to 99 parts by mass/1 to 20 parts by mass.

7. The fiber for artificial hair of claim 2, wherein a weight-average molecular weight of the maleimide-based copolymer is 25000 to 120000.

8. The fiber for artificial hair of claim 3, wherein a weight-average molecular weight of the maleimide-based copolymer is 25000 to 120000.

9. The fiber for artificial hair of claim 6, wherein a weight-average molecular weight of the maleimide-based copolymer is 25000 to 120000.

10. A hair decorating product comprising the fiber for artificial hair of claim 2.

11. A hair decorating product comprising the fiber for artificial hair of claim 3.

12. A hair decorating product comprising the fiber for artificial hair of claim 4.

13. A hair decorating product comprising the fiber for artificial hair of claim 6.

14. A hair decorating product comprising the fiber for artificial hair of claim 7.

15. A hair decorating product comprising the fiber for artificial hair of claim 8.

16. A hair decorating product comprising the fiber for artificial hair of claim 9.
